(19) United States
(12) Patent Application Publication
(10) Pub. No.: US 2024/0360337 A1
(43) Pub. Date: Oct. 31, 2024

(54) ROOFING SHINGLE, AND ASSOCIATED SYSTEM

(71) Applicant: BMIC LLC, Dallas, TX (US)

(72) Inventors: Denis Muki Tibah, Waxahachie, TX (US); Jarod L. Krajca, Ennis, TX (US); Steven E. Sparks, JR., Midlothian, TX (US)

(21) Appl. No.: 18/640,880

(22) Filed: Apr. 19, 2024

Related U.S. Application Data
(60) Provisional application No. 63/498,347, filed on Apr. 26, 2023.

(51) Int. Cl. C09D 195/00; C09D 5/02; C09D 129/14; C09D 133/12; E04D 1/00; E04D 1/20

(52) U.S. Cl. CPC C09D 195/00; C09D 5/022; C09D 5/028; C09D 129/14; C09D 133/12; E04D 1/20; E04D 2001/005

(57) ABSTRACT

A bundle of coated roofing shingles, including: at least a first coated roofing shingle and a second coated roofing shingle, where each of the first coated roofing shingle and the second coated roofing shingle includes: a substrate; an asphalt-filled coating on at least one surface of the substrate; a plurality of granules on the asphalt-filled coating; and a coating composition on at least a portion of the plurality of granules, where the coating composition includes at least one of a liquid-applied polymer, a polymer emulsion, or a thermoplastic polymer, where the coating composition is in a form of a polymer network.

### CROSS-REFERENCE TO RELATED APPLICATIONS

This application claims priority to provisional application No. 63/498,347, titled “ROOFING SHINGLE, AND ASSOCIATED SYSTEM,” filed Apr. 26, 2023, the disclosure of which is incorporated by reference herein in its entirety.

### FIELD

The present invention relates to a roofing shingle, and, more particularly, to a roofing shingle including granules.

### BACKGROUND

In a known roofing system, a plurality of roofing shingles are installed above a roof deck. The top surfaces of the roofing shingles include granules.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a bundle of coated roofing shingles, comprising: at least a first coated roofing shingle and a second coated roofing shingle, wherein each of the first coated roofing shingle and the second coated roofing shingle comprises: a substrate; an asphalt-filled coating on at least one surface of the substrate; a plurality of granules on the asphalt-filled coating; and a coating composition on the plurality of granules, wherein the coating composition comprises at least one of a liquid-applied polymer, a polymer emulsion, or a thermoplastic polymer.

In some embodiments, the coating composition is in a form of a polymer network.

In some embodiments, the coating composition is opaque.

In some embodiments, the coating composition is colored.

In some embodiments, the coating composition further comprises a pigment.

In some embodiments, the coating composition further comprises a dye.

In some embodiments, the coating composition is translucent.

In some embodiments, the coating composition is transparent.

In some embodiments, the coating composition further comprises at least one of: an antialgae agent, an antibacterial agent, an antioxidant, an ultraviolet stabilizer, an ultraviolet absorber, or a hydrophobic agent.

In some embodiments, the coating composition is cured using a catalyst.

In some embodiments, the liquid-applied polymer comprises an acrylic.

In some embodiments, the liquid-applied polymer comprises a methacrylate.

In some embodiments, the liquid-applied polymer comprises poly(methyl methacrylate).

In some embodiments, the polymer emulsion comprises a vinyl polymer.

In some embodiments, the vinyl polymer comprises polyvinyl butyral.

In some embodiments, the present invention provides a method, comprising: obtaining a plurality of roofing shingles, wherein the plurality of roofing shingles comprises at least a first roofing shingle and a second roofing shingle, wherein each of the first roofing shingle and the second roofing shingle comprises: a substrate; an asphalt-filled coating on at least one surface of the substrate; and a plurality of granules on the asphalt-filled coating; applying a first liquid coating composition to at least a portion of the plurality of granules of the first roofing shingle thereby to form a first polymer network and a first coated roofing shingle, wherein the first liquid coating composition comprises at least one of a liquid-applied polymer, a polymer emulsion, or a thermoplastic polymer; applying a second liquid coating composition to cover at least a portion of the plurality of granules of the second roofing shingle thereby to form a second polymer network and a second coated roofing shingle, wherein the second liquid coating composition comprises at least one of a liquid-applied polymer, a polymer emulsion, or a thermoplastic polymer; and stacking the first coated roofing shingle and the second coated roofing shingle thereby to form a shingle bundle.

In some embodiments, the present invention provides a method, comprising: obtaining a plurality of coated roofing shingles, wherein the plurality of coated roofing shingles comprises at least a first coated roofing shingle and a second coated roofing shingle, wherein each of the first coated roofing shingle and the second coated roofing shingle comprises: a substrate, wherein the substrate has a top surface and a bottom surface opposite the top surface; an asphalt-filled coating on at least the top surface of the substrate; a plurality of granules on the asphalt-filled coating, to form an uppermost surface; and a coating composition on the uppermost surface, wherein the coating composition comprises at least one of a liquid-applied polymer, a polymer emulsion, or a thermoplastic polymer, wherein the coating composition is in a form of a polymer network; and installing the first coated roofing shingle and the second coated roofing shingle above a roof deck.

### BRIEF DESCRIPTION OF THE FIGURES

This section refers to the drawings that form a part of this disclosure, and which illustrate some of the embodiments of structure, materials, and/or methods of the present invention described herein.

FIG. 1 is a top view of a coated roofing shingle, in accordance with some embodiments of the invention.

FIG. 2 is a cross-sectional view of the coated roofing shingle, in accordance with some embodiments of the invention.

FIG. 3 is a top view of a roofing system including the coated roofing shingle, in accordance with some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

In some embodiments, the present invention provides a coated roofing shingle. In some embodiments, present invention provides a bundle of coated roofing shingles. In some embodiments, the bundle comprises at least one coated roofing shingle. In some embodiments, the bundle comprises a plurality of coated roofing shingles. In some embodiments, the plurality of coated roofing shingles comprises at least a first coated roofing shingle and a second coated roofing shingle. In some embodiments, the plurality of coated roofing shingles comprises more than two coated roofing shingles.

In some embodiments, one or more of the coated roofing shingles comprises a substrate. In some embodiments, the substrate has a top surface, and a bottom surface that is opposite the top surface.

In some embodiments, the substrate comprises one or more of a cellulosic substrate, a woven mat, a nonwoven a fabric, a glass mat, a fiberglass mat, a polyester mat, a scrim, a coated scrim, a bitumen substrate, another material, and/or combinations thereof.

In some embodiments, an asphalt-filled coating or layer is on at least the top surface of the substrate. In some embodiments, the asphalt-filled coating is on at least the bottom surface of the substrate. In some embodiments, the asphalt-filled coating is on the top surface as well as the bottom surface of the substrate.

In some embodiments, the asphalt-filled coating comprises asphalt and a filler material. In some embodiments, the filler comprises limestone. In some embodiments, the asphalt comprises one or more of blown asphalt, polymer modified asphalt (PMA), another material, and/or combinations thereof.

In some embodiments, a plurality of granules is on the asphalt-filled coating that is on the top surface of the substrate, to form an uppermost surface.

In some embodiments, the granules comprise crushed stone. In some embodiments, the granules comprise andesite, nepheline syenite, mineral granules, synthetic rubber, recycled materials, another material, and/or combinations thereof.

In some embodiments, a coating composition is on the uppermost surface.

In some embodiments, the coating composition comprises at least one of a liquid-applied polymer, a polymer emulsion, and/or a thermoplastic polymer, or combinations thereof. In some embodiments, the coating composition is the liquid-applied polymer. In some embodiments, the coating composition is the polymer emulsion. In some embodiments, the coating composition is the polymer emulsion.

In some embodiments, the coating composition is in a form of a polymer network. In some embodiments, the coating composition is not in a form of a polymer network.

In some embodiments, a loading level of the coating composition is less than 2 wt. % based on the weight of the shingle. In some embodiments, a loading level of the coating composition is 2 wt. %. In some embodiments, the loading level of the coating composition is 3 wt. %. In some embodiments, the loading level of the coating composition is 4 wt. %. In some embodiments, the loading level of the coating composition is 5 wt. %. In some embodiments, the loading level of the coating composition is 10 wt. %. In some embodiments, the loading level of the coating composition is 15 wt. %. In some embodiments, the loading level of the coating composition is 20 wt. %. In some embodiments, the loading level of the coating composition is 25 wt. %. In some embodiments, the loading level of the coating composition is 30 wt. %. In some embodiments, the loading level of the coating composition is more than 30 wt. %.

In some embodiments, a loading level of the coating composition is 2 wt. % to 30 wt. %. In some embodiments, the loading level of the coating composition is 3 wt. % to 30 wt. %. In some embodiments, the loading level of the coating composition is 4 wt. % to 30 wt. %. In some embodiments, the loading level of the coating composition is 5 wt. % to 30 wt. %. In some embodiments, the loading level of the coating composition is 10 wt. % to 30 wt. %. In some embodiments, the loading level of the coating composition is 15 wt. % to 30 wt. %. In some embodiments, the loading level of the coating composition is 20 wt. % to 30 wt. %. In some embodiments, the loading level of the coating composition is 25 wt. % to 30 wt. %.

In some embodiments, the loading level of the coating composition is 5 wt. % to 25 wt. %. In some embodiments, the loading level of the coating composition is 10 wt. % to 25 wt. In some embodiments, the loading level of the coating composition is 5 wt. % to 20 wt.

In some embodiments, the coating reduces a rub loss of granules of the coated roofing shingle by less than 5% compared to an uncoated roofing shingle. In some embodiments, the rub loss is reduced by 5%. In some embodiments, the rub loss is reduced by 10%. In some embodiments, the rub loss is reduced by 15%. In some embodiments, the rub loss is reduced by 20%. In some embodiments, the rub loss is reduced by 30%. In some embodiments, the rub loss is reduced by 40%. In some embodiments, the rub loss is reduced by 50%. In some embodiments, the rub loss is reduced by 60%. In some embodiments, the rub loss is reduced by 70%. In some embodiments, the rub loss is reduced by 80%. In some embodiments, the rub loss is reduced by 90%. In some embodiments, the rub loss is reduced by 95%. In some embodiments, the rub loss is reduced by 96%. In some embodiments, the rub loss is reduced by 97%. In some embodiments, the rub loss is reduced by 98%. In some embodiments, the rub loss is reduced by 99%.

In some embodiments, the rub loss is reduced by 5% to 99%. In some embodiments, the rub loss is reduced by 10% to 99%. In some embodiments, the rub loss is reduced by 20% to 99%. In some embodiments, the rub loss is reduced by 30% to 99%. In some embodiments, the rub loss is reduced by 40% to 99%. In some embodiments, the rub loss is reduced by 50% to 99%. In some embodiments, the rub loss is reduced by 60% to 99%.

In some embodiments, the rub loss is reduced by 5% to 90%. In some embodiments, the rub loss is reduced by 10% to 90%. In some embodiments, the rub loss is reduced by 15% to 90%. In some embodiments, the rub loss is reduced by 20% to 90%. In some embodiments, the rub loss is reduced by 30% to 90%. In some embodiments, the rub loss is reduced by 40% to 90%. In some embodiments, the rub loss is reduced by 50% to 90%. In some embodiments, the rub loss is reduced by 60% to 90%.

In some embodiments, the rub loss is reduced by 5% to 80%. In some embodiments, the rub loss is reduced by 10% to 80%. In some embodiments, the rub loss is reduced by 15% to 80%. In some embodiments, the rub loss is reduced by 20% to 80%. In some embodiments, the rub loss is reduced by 30% to 80%. In some embodiments, the rub loss is reduced by 40% to 80%. In some embodiments, the rub loss is reduced by 50% to 80%.

In some embodiments, the rub loss is reduced by 5% to 70%. In some embodiments, the rub loss is reduced by 10% to 70%. In some embodiments, the rub loss is reduced by 15% to 70%. In some embodiments, the rub loss is reduced by 20% to 70%. In some embodiments, the rub loss is reduced by 30% to 70%. In some embodiments, the rub loss is reduced by 40% to 70%.

In some embodiments, the rub loss is reduced by 5% to 60%. In some embodiments, the rub loss is reduced by 10% to 60%. In some embodiments, the rub loss is reduced by 15% to 60%. In some embodiments, the rub loss is reduced by 20% to 60%. In some embodiments, the rub loss is reduced by 30% to 60%.

In some embodiments, the rub loss is reduced by 5% to 50%. In some embodiments, the rub loss is reduced by 10% to 50%. In some embodiments, the rub loss is reduced by 20% to 50%. In some embodiments, the rub loss is reduced by 5% to 40%. In some embodiments, the rub loss is reduced by 10% to 40%.

In some embodiments, the coating reduces a rub loss of granules of the coated roofing shingle after exposure of the shingle to weathering (that is, of the weathered shingle) by 5% compared to an uncoated roofing shingle. In some embodiments, the rub loss of the weathered shingle is reduced by 10%. In some embodiments, the rub loss is reduced by 15%. In some embodiments, the rub loss is reduced by 20%. In some embodiments, the rub loss is reduced by 30%. In some embodiments, the rub loss is reduced by 40%. In some embodiments, the rub loss is reduced by 50%. In some embodiments, the rub loss is reduced by 60%. In some embodiments, the rub loss is reduced by 70%. In some embodiments, the rub loss is reduced by 80%. In some embodiments, the rub loss is reduced by 90%. In some embodiments, the rub loss is reduced by 95%. In some embodiments, the rub loss is reduced by 96%. In some embodiments, the rub loss is reduced by 97%. In some embodiments, the rub loss is reduced by 98%. In some embodiments, the rub loss is reduced by 99%.

In some embodiments, the rub loss is reduced by 5% to 99%. In some embodiments, the rub loss is reduced by 10% to 99%. In some embodiments, the rub loss is reduced by 20% to 99%. In some embodiments, the rub loss is reduced by 30% to 99%. In some embodiments, the rub loss is reduced by 40% to 99%. In some embodiments, the rub loss is reduced by 50% to 99%. In some embodiments, the rub loss is reduced by 60% to 99%.

In some embodiments, the rub loss is reduced by 5% to 90%. In some embodiments, the rub loss is reduced by 10% to 90%. In some embodiments, the rub loss is reduced by 20% to 90%. In some embodiments, the rub loss is reduced by 30% to 90%. In some embodiments, the rub loss is reduced by 40% to 90%. In some embodiments, the rub loss is reduced by 50% to 90%. In some embodiments, the rub loss is reduced by 60% to 90%.

In some embodiments, the rub loss is reduced by 5% to 80%. In some embodiments, the rub loss is reduced by 10% to 80%. In some embodiments, the rub loss is reduced by 20% to 80%. In some embodiments, the rub loss is reduced by 30% to 80%. In some embodiments, the rub loss is reduced by 40% to 80%. In some embodiments, the rub loss is reduced by 50% to 80%.

In some embodiments, the rub loss is reduced by 5% to 70%. In some embodiments, the rub loss is reduced by 10% to 70%. In some embodiments, the rub loss is reduced by 20% to 70%. In some embodiments, the rub loss is reduced by 30% to 70%. In some embodiments, the rub loss is reduced by 40% to 70%.

In some embodiments, the rub loss is reduced by 5% to 60%. In some embodiments, the rub loss is reduced by 10% to 60%. In some embodiments, the rub loss is reduced by 20% to 60%. In some embodiments, the rub loss is reduced by 30% to 60%.

In some embodiments, the rub loss is reduced by 5% to 50%. In some embodiments, the rub loss is reduced by 10% to 50%. In some embodiments, the rub loss is reduced by 20% to 50%. In some embodiments, the rub loss is reduced by 5% to 40%. In some embodiments, the rub loss is reduced by 10% to 40%.

In some embodiments, the coating composition cures. In some embodiments, a catalyst is used to cure the coating composition. In some embodiments, the coating composition dries. In some embodiments, the coating composition both cures and dries. In some embodiments, the coating composition is opaque when applied. In some embodiments, the coating composition is opaque after curing. In some embodiments, the coating composition is opaque after drying. In some embodiments, the coating composition is opaque when applied, as well as after curing and/or drying.

In some embodiments, the coating composition is colored when applied. In some embodiments, the coating composition is colored after curing. In some embodiments, the coating composition is colored after drying. In some embodiments, the coating composition is colored when applied, as well as after curing and/or drying.

In some embodiments, the coating composition further comprises a pigment (colorant). In some embodiments, the coating composition further comprises a dye. In some embodiments, the coating combination comprises both a pigment and a dye. In some embodiments, the pigment and/or dye changes one or more of a color, pattern, texture, depth perception, design, and/or combinations thereof, of the roofing shingle.

In some embodiments, the coating composition is translucent when applied. In some embodiments, the coating composition is translucent after curing. In some embodiments, the coating composition is translucent after drying. In some embodiments, the coating composition is translucent when applied, as well as after curing and/or drying.

In some embodiments, the coating composition is transparent when applied. In some embodiments, the coating composition is transparent after curing. In some embodiments, the coating composition is transparent after drying. In some embodiments, the coating composition is transparent when applied, as well as after curing and/or drying.

In some embodiments, the coating composition is a liquid when applied (e.g., is a liquid-applied coating).

In some embodiments, the coating composition further comprises one or more of an antialgae agent, an antibacterial agent, an antioxidant, an ultraviolet stabilizer, an ultraviolet absorber, a hydrophobic agent, and/or combinations thereof.

In some embodiments, the curing and/or drying occurs at a temperature of 20° C. In some embodiments, the temperature is 30° C. In some embodiments, the temperature is 40° C. In some embodiments, the temperature is 50° C. In some embodiments, the temperature is 60° C. In some embodiments, the temperature is 70° C. In some embodiments, the temperature is 80° C. In some embodiments, the temperature is 90° C. In some embodiments, the temperature is 100° C. In some embodiments, the temperature is 110° C. In some embodiments, the temperature is 120° C. In some embodiments, the temperature is 130° C. In some embodiments, the temperature is 140° C. In some embodiments, the temperature is 150° C. In some embodiments, the temperature is 160° C. In some embodiments, the temperature is 170° C. In some embodiments, the temperature is 180° C. In some embodiments, the temperature is 190° C. In some embodiments, the temperature is 200° C. In some embodiments, the temperature is 210° C. In some embodiments, the temperature is 220° C. In some embodiments, the temperature is greater than 220° C.

In some embodiments, the temperature is 20 to 220° C. In some embodiments, the temperature is 40 to 220° C. In some embodiments, the temperature is 60 to 220° C. In some embodiments, the temperature is 80 to 220° C. In some embodiments, the temperature is 100 to 220° C. In some embodiments, the temperature is 120 to 220° C. In some embodiments, the temperature is 140 to 220° C. In some embodiments, the temperature is 160 to 220° C. In some embodiments, the temperature is 180 to 220° C. In some embodiments, the temperature is 200 to 220° C.

In some embodiments, the coating composition is at least one of applied with a sprayer, a brush, a roller, and combinations thereof.

In some embodiments, the coating composition may cure at ambient temperatures.

In some embodiments, the coating composition may crosslink into a semi-rigid or flexible thermoplastic layer. In some embodiments, the coating composition may crosslink into a flexible thermoset layer.

In some embodiments, the coating composition may be prepared by exposing a polymer or prepolymer or polymer resin to a catalyst, a predetermined temperature, a predetermined moisture level, air, light, a curing agent or medium, and combinations thereof.

In some embodiments, curing may be accelerated by increasing an amount of curing agent, an intensity of the curing energy source, or both.

In some embodiments, the coating composition comprise the liquid-applied polymer. In some embodiments, the liquid-applied polymer comprises an acrylic. In some embodiments, the liquid-applied polymer comprises a methacrylate. In some embodiments, the liquid-applied polymer comprises poly(methyl methacrylate). In some embodiments, the liquid-applied polymer comprises something other than an acrylic, a methacrylate, and poly(methyl methacrylate).

In some embodiments, the coating composition comprises the polymer emulsion. In some embodiments, the polymer emulsion comprises a vinyl polymer. In some embodiments, the polymer emulsion comprises something other than a vinyl polymer. In some embodiments, the vinyl polymer comprises polyvinyl butyral. In some embodiments, the vinyl polymer comprises something other than polyvinyl butyral.

In some embodiments, the coating increase a cross-direction tear strength of the coated roofing shingle 5% compared to an uncoated roofing shingle. In some embodiments, the cross-direction tear strength increases 10%. In some embodiments, the cross-direction tear strength increases 15%. In some embodiments, the cross-direction tear strength increases 20%. In some embodiments, the cross-direction tear strength increases 30%. In some embodiments, the cross-direction tear strength increases 40%. In some embodiments, the cross-direction tear strength increases 50%. In some embodiments, the cross-direction tear strength increases 60%. In some embodiments, the cross-direction tear strength increases 70%. In some embodiments, the cross-direction tear strength increases 80%. In some embodiments, the cross-direction tear strength increases 90%.

In some embodiments, the cross-direction tear strength increases 5% to 90%. In some embodiments, the cross-direction tear strength increases 10% to 90%. In some embodiments, the cross-direction tear strength increases 20% to 90%. In some embodiments, the cross-direction tear strength increases 30% to 90%. In some embodiments, the cross-direction tear strength increases 40% to 90%. In some embodiments, the cross-direction tear strength increases 50% to 90%. In some embodiments, the cross-direction tear strength increases 60% to 90%.

In some embodiments, the cross-direction tear strength increases 5% to 80%. In some embodiments, the cross-direction tear strength increases 10% to 80%. In some embodiments, the cross-direction tear strength increases 20% to 80%. In some embodiments, the cross-direction tear strength increases 30% to 80%. In some embodiments, the cross-direction tear strength increases 40% to 80%. In some embodiments, the cross-direction tear strength increases 50% to 80%.

In some embodiments, the cross-direction tear strength increases 5% to 70%. In some embodiments, the cross-direction tear strength increases 10% to 70%. In some embodiments, the cross-direction tear strength increases 20% to 70%. In some embodiments, the cross-direction tear strength increases 30% to 70%. In some embodiments, the cross-direction tear strength increases 40% to 70%.

In some embodiments, the cross-direction tear strength increases 5% to 60%. In some embodiments, the cross-direction tear strength increases 10% to 60%. In some embodiments, the cross-direction tear strength increases 20% to 60%. In some embodiments, the cross-direction tear strength increases 30% to 60%.

In some embodiments, the cross-direction tear strength increases 5% to 50%. In some embodiments, the cross-direction tear strength increases 10% to 50%. In some embodiments, the cross-direction tear strength increases 20% to 50%.

In some embodiments, the cross-direction tear strength increases 5% to 40%. In some embodiments, the cross-direction tear strength increases 10% to 40%. In some embodiments, the cross-direction tear strength increases 5% to 30%.

In some embodiments, the cross-direction tear strength of the coated roofing shingle is at least 1000 gf. In some embodiments, the cross-direction tear strength is at least 1100 gf. In some embodiments, the cross-direction tear strength is at least 1200 gf. In some embodiments, the cross-direction tear strength is at least 1300 gf. In some embodiments, the cross-direction tear strength is at least 1400 gf. In some embodiments, the cross-direction tear strength is at least 1500 gf. In some embodiments, the cross-direction tear strength is at least 1600 gf. In some embodiments, the cross-direction tear strength is at least 1700 gf. In some embodiments, the cross-direction tear strength is at least 1800 gf. In some embodiments, the cross-direction tear strength is at least 1900 gf. In some embodiments, the cross-direction tear strength is at least 2000 gf. In some embodiments, the cross-direction tear strength is at least 2100 gf. In some embodiments, the cross-direction tear strength is at least 2200 gf. In some embodiments, the cross-direction tear strength is at least 2300 gf. In some embodiments, the cross-direction tear strength is at least 2400 gf. In some embodiments, the cross-direction tear strength is at least 2500 gf.

In some embodiments, the coating increases a cross-direction tear strength of the coated roofing shingle exposed to the weather (that is, a weathered coated roofing shingle) 5% compared to an uncoated roofing shingle exposed to the weather (that is, a weathered uncoated roofing shingle). In some embodiments, the cross-direction tear strength increases 10%. In some embodiments, the cross-direction tear strength increases 15%. In some embodiments, the cross-direction tear strength increases 20%. In some embodiments, the cross-direction tear strength increases 30%. In some embodiments, the cross-direction tear strength increases 40%. In some embodiments, the cross-direction tear strength increases 50%. In some embodiments, the cross-direction tear strength increases 60%. In some embodiments, the cross-direction tear strength increases 70%. In some embodiments, the cross-direction tear strength increases 80%. In some embodiments, the cross-direction tear strength increases 90%.

In some embodiments, the cross-direction tear strength increases 5% to 90%. In some embodiments, the cross-direction tear strength increases 10% to 90%. In some embodiments, the cross-direction tear strength increases 20% to 90%. In some embodiments, the cross-direction tear strength increases 30% to 90%. In some embodiments, the cross-direction tear strength increases 40% to 90%. In some embodiments, the cross-direction tear strength increases 50% to 90%. In some embodiments, the cross-direction tear strength increases 60% to 90%.

In some embodiments, the cross-direction tear strength increases 5% to 80%. In some embodiments, the cross-direction tear strength increases 10% to 80%. In some embodiments, the cross-direction tear strength increases 20% to 80%. In some embodiments, the cross-direction tear strength increases 30% to 80%. In some embodiments, the cross-direction tear strength increases 40% to 80%. In some embodiments, the cross-direction tear strength increases 50% to 80%.

In some embodiments, the cross-direction tear strength increases 5% to 70%. In some embodiments, the cross-direction tear strength increases 10% to 70%. In some embodiments, the cross-direction tear strength increases 20% to 70%. In some embodiments, the cross-direction tear strength increases 30% to 70%. In some embodiments, the cross-direction tear strength increases 40% to 70%.

In some embodiments, the cross-direction tear strength increases 5% to 60%. In some embodiments, the cross-direction tear strength increases 10% to 60%. In some embodiments, the cross-direction tear strength increases 20% to 60%. In some embodiments, the cross-direction tear strength increases 30% to 60%.

In some embodiments, the cross-direction tear strength increases 5% to 50%. In some embodiments, the cross-direction tear strength increases 10% to 50%. In some embodiments, the cross-direction tear strength increases 20% to 50%. In some embodiments, the cross-direction tear strength increases 5% to 40%. In some embodiments, the cross-direction tear strength increases 10% to 40%.

In some embodiments, the cross-direction tear strength of the coated roofing shingle after exposure to the weather (that is, the weathered roofing shingle) is at least 1000 gf. In some embodiments, the cross-direction tear strength of the weathered roofing shingle is at least 1100 gf. In some embodiments, the cross-direction tear strength of the weathered roofing shingle is at least 1200 gf. In some embodiments, the cross-direction tear strength of the weathered roofing shingle is at least 1300 gf. In some embodiments, the cross-direction tear strength of the weathered roofing shingle is at least 1400 gf. In some embodiments, the cross-direction tear strength of the weathered roofing shingle is at least 1500 gf. In some embodiments, the cross-direction tear strength of the weathered roofing shingle is at least 1600 gf. In some embodiments, the cross-direction tear strength of the weathered roofing shingle is at least 1700 gf. In some embodiments, the cross-direction tear strength of the weathered roofing shingle is at least 1800 gf. In some embodiments, the cross-direction tear strength of the weathered roofing shingle is at least 1900 gf. In some embodiments, the cross-direction tear strength of the weathered roofing shingle is at least 2000 gf. In some embodiments, the cross-direction tear strength of the weathered roofing shingle is at least 2100 gf. In some embodiments, the cross-direction tear strength of the weathered roofing shingle is at least 2200 gf. In some embodiments, the cross-direction tear strength of the weathered roofing shingle is at least 2300 gf. In some embodiments, the cross-direction tear strength of the weathered roofing shingle is at least 2400 gf. In some embodiments, the cross-direction tear strength of the weathered roofing shingle is at least 2500 gf.

In some embodiments, the coating increases the total solar reflectance (TSR) of the roofing shingle by at least 1% as compared to an uncoated roofing shingle. In some embodiments, the coating increases the TSR by at least 2%. In some embodiments, the coating increases the TSR by at least 3%. In some embodiments, the coating increases the TSR by at least 4%. In some embodiments, the coating increases the TSR by at least 5%. In some embodiments, the coating increases the TSR by at least 6%. In some embodiments, the coating increases the TSR by at least 7%. In some embodiments, the coating increases the TSR by at least 8%. In some embodiments, the coating increases the TSR by at least 9%. In some embodiments, the coating increases the TSR by at least 10%. In some embodiments, the coating increases the TSR by at least 15%. In some embodiments, the coating increases the TSR by at least 20%. In some embodiments, the coating increases the TSR by at least 25%.

In some embodiments, the coating decreases the total solar reflectance (TSR) of the roofing shingle by at least 1% as compared to an uncoated roofing shingle. In some embodiments, the coating decreases the TSR by at least 2%. In some embodiments, the coating decreases the TSR by at least 3%. In some embodiments, the coating decreases the TSR by at least 4%. In some embodiments, the coating decreases the TSR by at least 5%. In some embodiments, the coating decreases the TSR by at least 6%. In some embodiments, the coating decreases the TSR by at least 7%. In some embodiments, the coating decreases the TSR by at least 8%. In some embodiments, the coating decreases the TSR by at least 9%. In some embodiments, the coating decreases the TSR by at least 10%. In some embodiments, the coating decreases the TSR by at least 15%. In some embodiments, the coating decreases the TSR by at least 20%. In some embodiments, the coating decreases the TSR by at least 25%.

In some embodiments, all of the shingles in the bundle are as described herein. In some embodiments, less than all of the shingles in the bundle are as described herein. In some embodiments, all of the shingles in the bundle have the same coating composition. In some embodiments, less than all of the shingles in the bundle have the same coating composition.

In some embodiments, the present invention provides a method comprising obtaining at least one roofing shingle, such as a first roofing shingle. In some embodiments, the present invention provides a method comprising obtaining a plurality of roofing shingles. In some embodiments, the present invention provides a method comprising obtaining a bundle of roofing shingles. In some embodiments, the plurality of roofing shingles or the bundle of roofing shingles comprises at least a first roofing shingle and a second roofing shingle. In some embodiments, the plurality of roofing shingles or the bundle of roofing shingles comprises more than two roofing shingles. In some embodiments, one of more of the roofing shingles are stacked on one another, thereby forming the shingle bundle.

In some embodiments, one or more of the roofing shingles comprises a substrate. In some embodiments, the substrate has a top surface and a bottom surface opposite the top surface, as described herein. In some embodiments, an asphalt-filled coating is on at least the top surface of the substrate, as described herein. In some embodiments, the asphalt-filled coating is on at least the bottom surface of the substrate. In some embodiments, the asphalt-filled coating is on the top surface as well as the bottom surface of the substrate. In some embodiments, the asphalt-filled coating completely coats all surfaces of the substrate.

In some embodiments, a plurality of granules is on the asphalt-filled coating that is on the top surface of the substrate, to form an uppermost surface, as described herein.

In some embodiments, the method comprises coating the plurality of granules of the one or more of the roofing shingles with a coating composition. In some embodiments, at least a portion of the plurality of granules are coated. In some embodiments, an entirety of the plurality of granules are coated. In some embodiments, the method comprises coating the uppermost surface of the one or more of the roofing shingles with a coating composition. In some embodiments, the coating composition comprises at least one of a liquid-applied polymer, a polymer emulsion, and/or a thermoplastic polymer, as described herein.

In some embodiments, the present invention provides a method, comprising: obtaining at least one coated roofing shingle, as described herein. In some embodiments, the method further comprises installing the coated roofing shingle and above a roof deck.

In some embodiments, the coating composition is applied to a roofing shingle prior to installation above the roof deck, as described. In some embodiments, the coating composition is applied to one or more roofing shingles already installed above the roof deck.

In some embodiments, the granules may comprise coated granules. In some embodiments, the coated granules including base particles and a granule coating that covers the base particles. In some embodiments, the liquid-applied coating composition is applied to the coated granules. In some embodiments, the liquid-applied coating composition is applied so as to at least partially cover the coated granules. In some embodiments, the liquid-applied coating composition is applied so as to fully cover the coated granules.

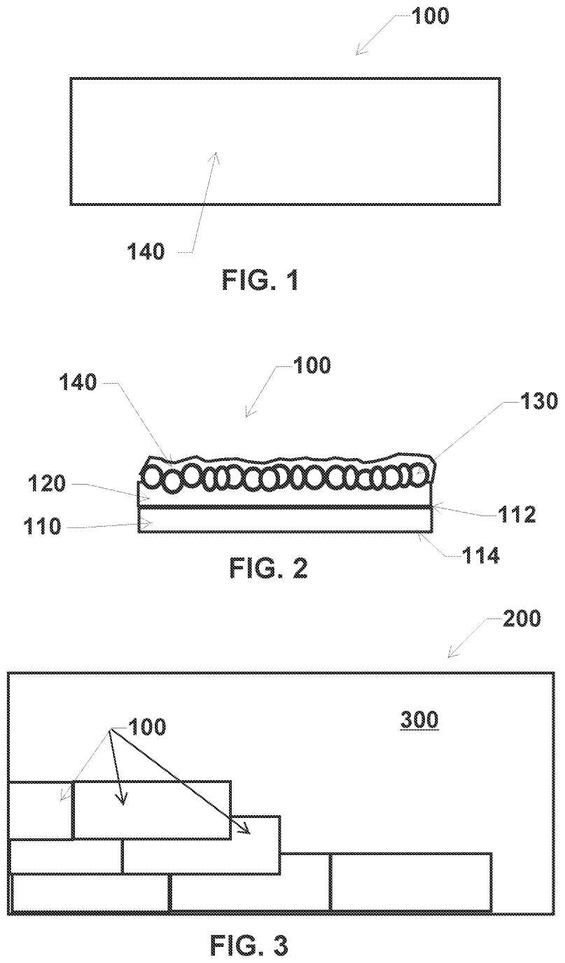

With reference to the figures, FIG. 1 shows a top view of a coated roofing shingle 100, FIG. 2 is a cross-sectional view of the coated roofing shingle 100, and FIG. 3 is a top view of a roofing system 200 including a plurality of the coated roofing shingles 100, in accordance with some embodiments of the invention.

The coated roofing shingle 100 may be in accordance with the roofing shingle described herein. As shown, the roofing shingle 100 may include a substrate 110, as described. The substrate may have a top surface 112, and a bottom surface 114 that is opposite the top surface 112. The roofing shingle 100 may include an asphalt-filled coating 120 on the top surface 112 of the substrate 110, as described. The roofing shingle 100 may include a plurality of granules 130 on the asphalt-filled coating 120. The plurality of granules 130 may for an uppermost surface of the coated roofing shingle 100. A coating composition 140, as described herein, may cover the granules 130.

Also as shown, the roofing system 200 may include one or more of the coated roofing shingles 100 (either full and/or partial shingles), installed above a roof deck 300, as described herein.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A bundle of coated roofing shingles, comprising:
at least a first coated roofing shingle and a second coated roofing shingle,
wherein each of the first coated roofing shingle and the second coated roofing shingle comprises:
a substrate;
an asphalt-filled coating on a surface of the substrate;
a plurality of granules on the asphalt-filled coating; and
a coating composition on the plurality of granules,
wherein the coating composition comprises at least one of:
a liquid-applied polymer,
a polymer emulsion, or
a thermoplastic polymer.

2. The bundle of coated roofing shingles of claim 1, wherein the coating composition is opaque.

3. The bundle of coated roofing shingles of claim 1, wherein the coating composition is colored.

4. The bundle of coated roofing shingles of claim 1, wherein the coating composition further comprises at least one of a pigment or a dye.

5. The bundle of coated roofing shingles of claim 1, wherein the coating composition is translucent or transparent.

6. The bundle of coated roofing shingles of claim 1, wherein the coating composition further comprises at least one of an antialgae agent, an antibacterial agent, an antioxidant, an ultraviolet stabilizer, an ultraviolet absorber, or a hydrophobic agent.

7. The bundle of coated roofing shingles of claim 1, wherein the coating composition is cured using a catalyst.

8. The bundle of coated roofing shingles of claim 1, wherein the liquid-applied polymer comprises an acrylic.

9. The bundle of coated roofing shingles of claim 1, wherein the liquid-applied polymer comprises a methacrylate.

10. The bundle of coated roofing shingles of claim 1, wherein the liquid-applied polymer comprises poly(methyl methacrylate).

11. The bundle of coated roofing shingles of claim 1, wherein the polymer emulsion comprises a vinyl polymer.

12. The bundle of coated roofing shingles of claim 11, wherein the vinyl polymer comprises polyvinyl butyral.

13. A method, comprising:
obtaining a plurality of roofing shingles,
wherein the plurality of roofing shingles comprises at least a first roofing shingle and a second roofing shingle,
wherein each of the first roofing shingle and the second roofing shingle comprises:
a substrate;
an asphalt-filled coating on at least one surface of the substrate; and
a plurality of granules on the asphalt-filled coating;
applying a first liquid coating composition to cover at least a portion of the plurality of granules of the first roofing shingle, thereby to form a first coated roofing shingle,
wherein the first liquid coating composition comprises at least one of:
a liquid-applied polymer,
a polymer emulsion, or
a thermoplastic polymer;
applying a second liquid coating composition to cover at least a portion of the plurality of granules of the second roofing shingle, thereby to form a second coated roofing shingle,
wherein the second liquid coating composition comprises at least one of:
a liquid-applied polymer,
a polymer emulsion, or
a thermoplastic polymer; and
stacking the first coated roofing shingle and the second coated roofing shingle thereby to form a shingle bundle.

14. The method of claim 13, wherein at least one of the first liquid coating composition or the second liquid coating composition further comprises at least one of a pigment or a dye.

15. The method of claim 13, wherein at least one of the first liquid coating composition or the second liquid coating composition further comprises at least one of an antialgae agent, an antibacterial agent, an antioxidant, an ultraviolet stabilizer, an ultraviolet absorber, or a hydrophobic agent.

16. The method of claim 13, wherein at least one of the first liquid coating composition or the second liquid coating composition comprises the liquid-applied polymer,
wherein the liquid-applied polymer comprises an acrylic.

17. The method of claim 16, wherein the liquid-applied polymer comprises a methacrylate.

18. The method of claim 17, wherein the liquid-applied polymer comprises poly(methyl methacrylate).

19. The method of claim 13, wherein at least one of the first liquid coating composition or the second liquid coating composition comprises the polymer emulsion,
wherein the polymer emulsion comprises a vinyl polymer.

20. The method of claim 19, wherein the vinyl polymer comprises polyvinyl butyral.
